(19) United States
(12) Patent Application Publication
(10) Pub. No.: US 2025/0070378 A1
(43) Pub. Date: Feb. 27, 2025

(54) THERMAL RUNAWAY EXHAUST DELAY MECHANISM

(71) Applicant: FCA US LLC, Auburn Hills, MI (US)

(72) Inventors: Uday Mahakali, Novi, MI (US); Shreekanth Surapaneni, Oakland, MI (US); Venkata Chagarlamudi, Rochester Hills, MI (US)

(21) Appl. No.: 18/454,845

(22) Filed: Aug. 24, 2023

(51) Int. Cl. H01M 50/358; H01M 50/249; H01M 50/325; H01M 50/342; H01M 50/383

(52) U.S. Cl. CPC H01M 50/358; H01M 50/249; H01M 50/325; H01M 50/342; H01M 50/383

(57) ABSTRACT

A vehicle including a battery pack including housing having a plurality of battery modules contained therein. The housing includes a plurality of vents for discharging battery gases generated by the plurality of battery modules. A plurality of discharge pipes are in communication with each of the vents, and a temporary storage system is connected to the discharge pipes and configured to selectively store the battery gases received from the discharge pipes, wherein the temporary storge system includes a collection container and an outlet valve, and the outlet valve is configured to discharge the battery gases from the collection container upon a predetermined pressure threshold being reached within the collection container.

### FIELD

The present disclosure relates to an electric vehicle having a thermal runaway exhaust delay mechanism.

### BACKGROUND

This section provides background information related to the present disclosure which is not necessarily prior art.

Vehicles with electric propulsion systems are becoming increasingly more common. Some electrically propelled vehicles include an electric drive motor at each wheel of the vehicle, and some electrically propelled vehicles include a front electric drive motor for rotating the front wheels of the vehicle and a rear electric drive motor for rotating the rear wheels of the vehicle. In either case, the electric drive motors receive power from a battery pack that includes a plurality of battery cells therein. Example battery cells include lithium-ion battery cells and lithium-metal battery cells.

Lithium-ion and lithium-metal battery cells sometimes undergo a process called thermal runaway during failure conditions. Thermal runaway may result in a rapid increase of battery cell temperature accompanied by the release of various gases, which in some cases may be flammable. These flammable gases may be ignited by the high temperature of the battery, which may result in a fire. Accordingly, in the event of a thermal runaway, it is desirable that the vehicle include features that assist in preventing, or at least substantially minimizing, the ignition of various gases that are generated during the thermal runaway.

### SUMMARY

This section provides a general summary of the disclosure, and is not a comprehensive disclosure of its full scope or all of its features.

According to a first aspect of the present disclosure, there is provided a vehicle that includes a battery pack including housing having a plurality of battery modules contained therein, the housing including a plurality of vents for discharging battery gases generated by the plurality of battery modules; a plurality of discharge pipes in communication with each of the vents; and a temporary storage system connected to the discharge pipes and configured to selectively store the battery gases received from the discharge pipes, wherein the temporary storge system includes a collection container and an outlet valve, the outlet valve configured to discharge the battery gases from the collection container upon a predetermined pressure threshold being reached within the collection container.

According to the first aspect, the collection container includes a non-deployed configuration when no battery gases are being discharged from the vents and a deployed configuration where the collection container expands after receipt of the battery gases from the discharge pipes via the vents.

According to the first aspect, the collection container is configured to inflate to the deployed configuration upon receipt of the battery gases.

According to the first aspect, the collection container is formed of a woven fabric that is heat- and flame-resistant.

According to the first aspect, the outlet valve is configured to close when a pressure within the collection container falls beneath the predetermined threshold at which time the collection container begins to collect and store the battery gases received from the discharge pipes to provide a time interval between discharges of the battery gases by the outlet valve.

According to the first aspect, in the deployed configuration of the collection container, the outlet valve is located outboard from the vehicle.

According to the first aspect, each of the plurality of vents includes a one-way valve.

According to a second aspect of the present disclosure, there is provided a method for selectively storing battery gases generated by a plurality of battery modules stored in a housing of a battery pack of a vehicle. The method includes discharging the battery gases through a plurality of vents of the battery pack to a temporary storage system in communication with the vents; collecting the battery gases discharged through the plurality of vents in a collection container having an outlet valve; and discharging the battery gases from the outlet valve once a volume of the battery gases collected by the collection container yields a pressure in the collection container above a predetermined threshold; wherein after discharging the battery gases from the outlet valve, the pressure in the collection container falls below the predetermined threshold and the outlet valve closes, at which time the collection container begins to collect and store the battery gases received from the vents to provide a time interval between discharges of the battery gases by the outlet valve.

According to the second aspect, the collecting the battery gases in the collection container includes expanding the collection container from a non-deployed condition to a deployed condition.

According to the second aspect, the expanding the collection container includes inflating the collection container with the battery gases.

According to the second aspect, the collection container is formed of a woven fabric that is heat- and flame-resistant.

According to the second aspect, in the deployed configuration of the collection container, the outlet valve is located outboard from the vehicle.

According to the second aspect, as the pressure in the collection container falls to the predetermined threshold while the battery gases are discharged by the outlet valve, the collection container is configured to deflate.

According to the second aspect, the vents are in communication with discharge pipes located between the vents and the collection container, and the collecting the battery gases discharged through the plurality of vents includes receiving the battery gases from the discharge pipes.

According to the second aspect, the method further comprises folding and storing the collection container proximate the battery pack.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of a vehicle including a battery gas discharge delay apparatus in a non-deployed state;

FIG. 2 is a perspective view of an example battery pack that may be part of the vehicle illustrated in FIG. 1;

FIG. 3 is a side perspective view of the battery pack illustrated in FIG. 2; and

FIG. 4 is a schematic illustration of the vehicle illustrated in FIG. 1, with the battery gas discharge delay apparatus in a deployed state.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

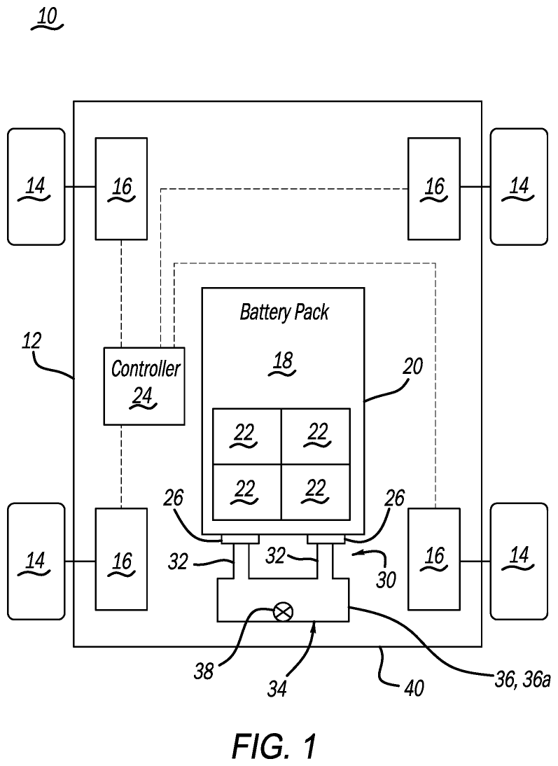

FIG. 1 schematically illustrates an electric vehicle 10 according to the present disclosure. Vehicle 10 includes a body 12, a plurality of wheels 14. In the illustrated embodiment, each wheel 14 is driven using a respective electric drive module 16 that receives electric power from a battery pack 18 having a housing 20 that encases a plurality of battery cells 22. Example battery cells 22 include lithium-ion battery cells, lithium-metal battery cells, and combinations thereof. It should be understood, however, that other types of battery cells 22 known to one skilled in the art may be used, without limitation. Housing 20 is preferably formed of a rigid metal material (e.g., steel, aluminum, and the like) that is resistant to puncture and is non-flammable.

While FIG. 1 illustrates four electric drive modules 16 such that each wheel 14 can be driven by a single electric drive module 16, it should be understood that vehicle 10 may include a single electric drive module 16 for driving a pair of wheels 14 (e.g., for driving the pair of front wheels 14 or the pair of rear wheels 14), or may include a pair of electric drive modules 16 with one of the electric drive modules 16 driving the front pair of wheels 14 and another of the electric drive modules 16 driving the rear pair of wheels 14. Regardless of the configuration selected, it should be understood that electric drive modules 16 receive a voltage or current from battery pack 18 that is utilized by the electric drive module 16 to drive the wheels 14 of the vehicle 10.

Vehicle 10 also includes a controller 24 in communication with each of the drive modules 16 and in communication with the battery pack 18. Controller 24 may be used to control electric drive modules 16 to control a speed of vehicle 10 and may also be used to monitor and/or communicate with various systems of vehicle such as an HVAC system (not shown), a vehicle braking system (not shown), and any other system that may be part of vehicle 10.

As noted above, battery cells 22 may sometimes undergo a process called thermal runaway during failure conditions of the battery cell(s) 22. Thermal runaway may result in a rapid increase of battery cell temperature accompanied by the release of various gases, which in some cases may be flammable. Example gases that may be released during a thermal runaway event include hydrogen (H₂), carbon monoxide (CO), carbon dioxide (CO₂), and various hydrocarbons including, but not limited to, methane, ethane, ethylene, acetylene, propane, cyclopropane, and butane. As these gases are released and the temperature of battery pack 18 increases, the pressure within battery pack 18 also increases.

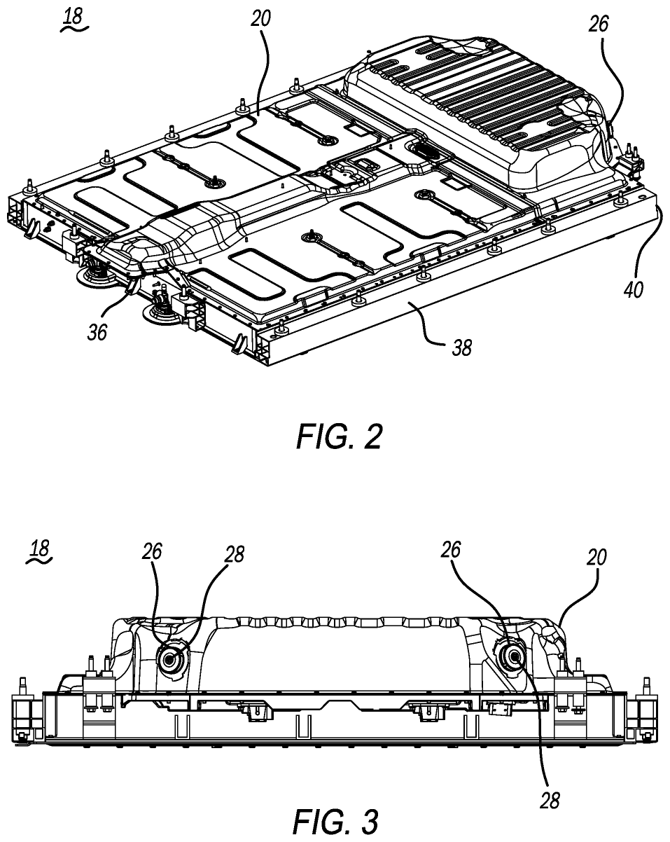

Now referring to FIG. 2, it can be seen that housing 20 of battery pack 18 includes a plurality of discharge vents 26 that permit the pressure and gases to escape housing 20 during a thermal runaway event. Discharge vents 26 may each include a valve 28 (FIG. 3) that may be a one-way valve and opens upon a predetermined pressure threshold being generated within housing 16. For example, if the pressure within housing 20 reaches 100 millibars the valves 28 may open and permit the gases within housing 20 to exit the battery pack 18. Discharge vents 26 may be in communication with various conduits (not shown) located in battery pack 18, which direct the gases generated during the thermal runaway event to the discharge vents 26 to be expelled from battery pack 20.

While housing 20 may include discharge vents 26 including valves 28 for releasing the gases from battery pack 12, the gases released from battery pack 18 may collect beneath the vehicle 10. While only a pair of discharge vents 26 including valves 28 are illustrated in FIGS. 2 and 3, it should be understood that battery pack 18 may include a greater number of discharge vents 26 having valves 28 without departing from the scope of the present disclosure. If the gases are at a sufficient temperature, the gases may combust after exiting battery pack 18 at a location beneath vehicle 10. If this occurs, there is the potential for other features of the vehicle 10 to also combust including, for example, the tires (not shown) of the wheels 14, hoses (not shown), vehicle brakes (not shown) and other features.

In view of the above, the present disclosure provides a battery gas discharge delay apparatus 30 that is configured to collect the battery gases discharged from vents 26. After the battery gases have been collected by the discharge delay apparatus 30, the apparatus 30 is configured to release the collected battery gases to the atmosphere and again repeat the process. That is, the battery gases may be collected by apparatus 30 and then vented to the atmosphere, and then additional battery gases may be collected by apparatus 30 and then subsequently vented to the atmosphere. This process may repeat until the battery gases are no longer being discharged by vents 26.

Discharge delay apparatus 30 may include a pair of discharge pipes 32 in communication with vents 26. Discharge pipes 32 may be formed of a rigid material such as a metal material, or formed of a flexible material such as a woven polymeric fabric that his flame- and heat-resistant. In either case, discharge pipes 32 are configured to receive battery gases generated by battery modules 22 during a thermal runaway event via vents 26.

A temporary storage system 34 is connected to discharge pipes 32 that includes a collection container 36 having an outlet valve 38. Outlet valve 38 may be a pressure-activated valve that, based on a pressure within collection container 36, may selectively permit the battery gases to be discharged therefrom. That is, once the pressure within collection container 36 reaches a predetermined threshold (e.g., 100 millibars) outlet valve 38 is configured to open and permit the battery gases collected by collection container 36 to be discharged therefrom. Notably, outlet valve 38 is located proximate a rear 40 of vehicle 10 such that the battery gases discharged in direction away from vehicle 10. When the pressure within collection container 36 falls below the predetermined threshold, outlet valve 38 is configured to close and permit collection container 36 to gather additional battery gases that are being discharged by vents 26 until the pressure threshold is again reached, at which time outlet valve 38 will again reopen and discharge the battery gases gathered by collection container 36. This process may repeat until the thermal runaway event has ended. By controlling (i.e., delaying) the discharge of the battery gases from collection container 36 in this manner, time intervals between discharges of the hot battery gases from collection container can be created. During these time intervals, occupants may exit the vehicle 10 or first responders attending to the thermal runaway event can approach the vehicle 10 and provide assistance to the occupants or conduct safety operations to address the thermal runaway event.

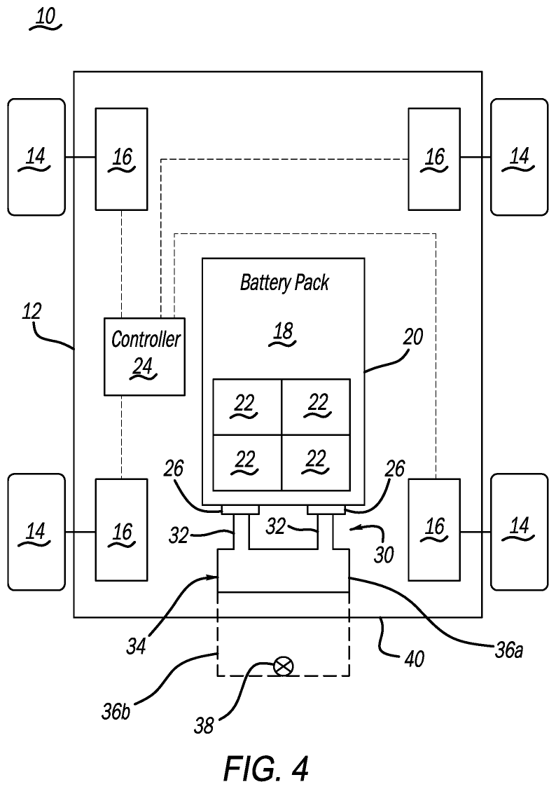

Collection container 36 may an expandable container. In this regard, FIG. 1 illustrates collection container 36 in a non-expanded state 36a. Upon receipt of the battery gases from discharge pipes 32, collection container 36 may expand to collect a greater volume of gases being discharged by vents 26 as shown in FIG. 4, where collection container is in an expanded state 36b and outlet valve 38 is located at a position outboard from rear 40 of vehicle 10.

To enable collection container 36 to expand in this manner, collection container 36 may be formed of a woven fabric that is configured to inflate in a manner similar to a vehicle airbag. Example woven fabrics include polymeric materials such as polyamide (e.g., NYLON®), which may be coated with heat- and flame-resistant materials. Alternatively, the woven fabric may be uncoated. In either case, collection container 36 is heat- and flame-resistant such that collection of the hot battery exhaust gases will not degrade the integrity of collection container 36 before pressurizing collection container to an extent where outlet valve 38 opens and discharges the battery exhaust gases to the atmosphere. In addition, forming collection container 36 from a woven fabric material permits collection container 36 to be folded in a manner similar to a vehicle airbag, which assists in less packaging restraints for locating collection container 36 relative to battery pack 18 when temporary storage system 24 is not in use. Once gases are received by collection container 36 from discharge pipes 32, collection container 36 will unfold, expand, and then become pressurized until outlet valve 38 permits the battery gases to be discharged from collection container 36.

As noted above, outlet valve 38 is pressure-activated and only opens upon a predetermined pressure threshold being reached within collection container 36. After discharging the gases, collection container 36 may deflate and outlet valve 38 may close. At this time, collection container 36 may continue to receive battery gases from vents 26 and re-inflate as the gases are collected within container 36. The re-inflation of collection container 36 provides the above-noted time interval or delay between battery gas discharges by outlet valve 38.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a battery pack including housing having a plurality of battery modules contained therein, the housing including a plurality of vents for discharging battery gases generated by the plurality of battery modules;
a plurality of discharge pipes in communication with each of the vents; and
a temporary storage system connected to the discharge pipes and configured to selectively store the battery gases received from the discharge pipes,
wherein the temporary storge system includes a collection container and an outlet valve, the outlet valve configured to discharge the battery gases from the collection container upon a predetermined pressure threshold being reached within the collection container.

2. The vehicle according to claim 1, wherein the collection container includes a non-deployed configuration when no battery gases are being discharged from the vents and a deployed configuration where the collection container expands after receipt of the battery gases from the discharge pipes via the vents.

3. The vehicle according to claim 2, wherein the collection container is configured to inflate to the deployed configuration upon receipt of the battery gases.

4. The vehicle according to claim 3, wherein the collection container is formed of a woven fabric that is heat- and flame-resistant.

5. The vehicle according to claim 3, wherein the outlet valve is configured to close when a pressure within the collection container falls beneath the predetermined threshold at which time the collection container begins to collect and store the battery gases received from the discharge pipes to provide a time interval between discharges of the battery gases by the outlet valve.

6. The vehicle according to claim 3, wherein in the deployed configuration of the collection container, the outlet valve is located outboard from the vehicle.

7. The vehicle according to claim 1, wherein each of the plurality of vents includes a one-way valve.

8. A method for selectively storing battery gases generated by a plurality of battery modules stored in a housing of a battery pack of a vehicle, comprising:
discharging the battery gases through a plurality of vents of the battery pack to a temporary storage system in communication with the vents;
collecting the battery gases discharged through the plurality of vents in a collection container having an outlet valve; and
discharging the battery gases from the outlet valve once a volume of the battery gases collected by the collection container yields a pressure in the collection container above a predetermined threshold;
wherein after discharging the battery gases from the outlet valve, the pressure in the collection container falls below the predetermined threshold and the outlet valve closes, at which time the collection container begins to collect and store the battery gases received from the vents to provide a time interval between discharges of the battery gases by the outlet valve.

9. The method according to claim 8, wherein the collecting the battery gases in the collection container includes expanding the collection container from a non-deployed condition to a deployed condition.

10. The method according to claim 9, wherein the expanding the collection container includes inflating the collection container with the battery gases.

11. The method according to claim 10, wherein the collection container is formed of a woven fabric that is heat- and flame-resistant.

12. The method according to claim 10, wherein in the deployed configuration of the collection container, the outlet valve is located outboard from the vehicle.

13. The method according to claim 10, wherein as the pressure in the collection container falls to the predetermined threshold while the battery gases are discharged by the outlet valve, the collection container is configured to deflate.

14. The method according to claim 8, wherein the vents are in communication with discharge pipes located between the vents and the collection container, and the collecting the battery gases discharged through the plurality of vents includes receiving the battery gases from the discharge pipes.

15. The method according to claim 8, wherein the method further comprises folding and storing the collection container proximate the battery pack.
